(19) United States
(12) Patent Application Publication
(10) Pub. No.: US 2025/0211480 A1
(43) Pub. Date: Jun. 26, 2025

(54) DATA PACKET TRANSMISSION CONTROL METHOD AND APPARATUS BASED ON ACTIVE MACHINE AND STANDBY MACHINE, DEVICE, AND MEDIUM

(71) Applicant: Tencent Technology (Shenzhen) Company Limited, Shenzhen (CN)

(72) Inventors: Qiuxiang LI, Shenzhen (CN); Jingwei LIU, Shenzhen (CN); Jiaxin FENG, Shenzhen (CN); Wei CHEN, Shenzhen (CN); Pan FANG, Shenzhen (CN); Yachen WANG, Shenzhen (CN)

(21) Appl. No.: 19/079,317

(22) Filed: Mar. 13, 2025

Related U.S. Application Data
(63) Continuation of application No. PCT/CN2023/130007, filed on Nov. 6, 2023.

(30) Foreign Application Priority Data
Feb. 1, 2023 (CN) 202310119590.9

(51) Int. Cl. H04L 41/0663; H04L 47/19

(52) U.S. Cl. CPC H04L 41/0663; H04L 47/196

(57) ABSTRACT

This application provides a data packet transmission control method based on an active machine and a standby machine performed by an electronic device. The electronic device adjusts, after a standby machine is promoted to an active machine, a network protocol stack state of the standby machine to be synchronized with a network protocol stack state of the active machine through transmission indication information obtained from a network element device for a data packet. Next, the electronic device performs data packet transmission processing between the standby machine and the network element device based on the network protocol stack state of the standby machine synchronized with the network protocol stack state of the active machine.

### CROSS-REFERENCE TO RELATED APPLICATIONS

This application is a continuation application of PCT Patent Application No. PCT/CN2023/130007, entitled “DATA PACKET TRANSMISSION CONTROL METHOD AND APPARATUS BASED ON ACTIVE MACHINE AND STANDBY MACHINE, DEVICE, AND MEDIUM” filed on Nov. 6, 2023, which claims priority to Chinese Patent Application No. 202310119590.9, entitled “DATA PACKET TRANSMISSION CONTROL METHOD AND APPARATUS BASED ON ACTIVE MACHINE AND STANDBY MACHINE, DEVICE, AND MEDIUM” filed on Feb. 1, 2023, all of which are incorporated herein by reference in their entirety.

### FIELD OF THE TECHNOLOGY

This application relates to the field of communication technologies, and in particular, to a data packet transmission control method based on an active machine and a standby machine, a data packet transmission control apparatus based on an active machine and a standby machine, an electronic device, and a computer-readable medium.

### BACKGROUND OF THE DISCLOSURE

In the related art of a 5G core network, to ensure reliability of network element devices, a 1+1 active-standby scheme is usually adopted. In the scheme, one network element device serves as a primary core network element device (referred to as an active machine for short) to process a related service, and another network element device serves as a backup core network element device (referred to as a standby machine for short). When the active machine fails, the standby machine is promoted to the active machine and undertake processing of related services.

The active machine transmits a related processing message to the standby machine when processing the related services, so that the standby machine performs synchronization. However, in actual application, related processing information may be lost as a result of impact such as a network or another factor, causing a network protocol stack state of the standby machine not to be completely synchronized with a network protocol stack state of the active machine. Therefore, although the standby machine is promoted to the active machine, a connection between the standby machine and an external network element device is interrupted, and data packet transmission cannot be continued, which greatly affects normal processing of services.

Therefore, how to improve rationality of data packet transmission control based on the active machine and the standby machine, to ensure normal processing of services is a problem needs to be resolved urgently.

### SUMMARY

Embodiments of this application provide a data packet transmission control method and apparatus based on an active machine and a standby machine, a device, and a medium, to improve rationality of data packet transmission control based on an active machine and a standby machine, and ensure normal processing of services after switching of the active machine and the standby machine.

According to a first aspect, an embodiment of this application provides a data packet transmission control method based on an active machine and a standby machine performed by an electronic device, the method including: obtaining transmission indication information from a network element device for a data packet after the standby machine switches from a standby machine operating mode to an active machine operating mode, the transmission indication information being configured for indicating data packet information of a data packet to be transmitted between the standby machine and the network element device; adjusting a network protocol stack state of the standby machine to be synchronized with a network protocol stack state of the active machine based on the data packet information; and performing data packet transmission processing between the standby machine and the network element device based on the adjusted network protocol stack state of the standby machine.

According to a second aspect, an embodiment of this application provides a data packet transmission control method based on an active machine and a standby machine, the method including: obtaining a data packet to be transmitted to a network element device if it is detected that the standby machine switches to an active machine operating mode; transmitting the data packet to the standby machine, to cause the standby machine to obtain transmission indication information of the network element device for the data packet based on the data packet, and determining a to-be-transmitted data packet based on the transmission indication information; and receiving the data packet transmitted by the standby machine.

According to a third aspect, an embodiment of this application provides a data packet transmission control apparatus based on an active machine and a standby machine, the apparatus including: an obtaining module, configured to obtain transmission indication information from a network element device for a data packet after a standby machine switches from a standby machine operating mode to an active machine operating mode, the transmission indication information being configured for indicating data packet information of a data packet to be transmitted between the standby machine and the network element device; an adjustment module, configured to adjust a network protocol stack state of the standby machine to be synchronized with a network protocol stack state of the active machine based on the data packet information; and a transmission processing module, configured to perform data packet transmission processing between the standby machine and the network element device based on the adjusted network protocol stack state of the standby machine.

According to a fourth aspect, an embodiment of this application provides a data packet transmission control apparatus based on an active machine and a standby machine, the apparatus including: an obtaining module, configured to obtain a data packet to be transmitted to a network element device if it is detected that the standby machine switches to an active machine operating mode; a transmission module, configured to transmit the data packet to the standby machine, to cause the standby machine to obtain transmission indication information of the network element device for the data packet based on the data packet, and determine a to-be-transmitted data packet based on the transmission indication information; and a receiving module, configured to receive the data packet transmitted by the standby machine.

According to a fifth aspect, an embodiment of this application provides an electronic device, including one or more processors; and a memory, configured to store one or more programs, the one or more programs, when executed by one or more processors, causing the electronic device to implement the foregoing data packet transmission control method based on an active machine and a standby machine.

According to a sixth aspect, an embodiment of this application provides a non-transitory computer-readable medium, having a computer program stored therein, the computer program, when executed by a processor, implementing the foregoing data packet transmission control method based on an active machine and a standby machine.

According to a seventh aspect, an embodiment of this application provides a computer program product, including a computer instruction, the computer instruction, when executed by a processor, implementing the foregoing data packet transmission control method based on an active machine and a standby machine.

In technical solutions provided in the embodiments of this application, after the standby machine is promoted to the active machine, the network protocol stack state of the standby machine may be adjusted to be synchronized with the network protocol stack state of the active machine through the obtained transmission indication information of the network element device for the data packet, and data packet transmission processing between the standby machine and the network element device may be performed based on the network protocol stack state of the standby machine synchronized with the network protocol stack state of the active machine.

In one aspect, consistency of the network protocol stack state of the standby machine and the network protocol stack state of the active machine is maintained through the transmission indication information, so that data packet transmission may be performed between the standby machine and the network element device. Data packet transmission control based on the active machine and the standby machine is more reasonable, and normal processing of services after the active machine and the standby machine are switched is ensured. More specifically, even if the connection between the standby machine and an external network element device is interrupted after the standby machine is promoted to the active machine, the consistency of the network protocol stack state of the standby machine and the network protocol stack state of the active machine may be maintained in real time through the transmission indication information, so that connection between the standby machine and the network element device is re-established for data packet transmission, thereby avoiding a phenomenon in the related art that the standby machine is promoted to the active machine but the connection between the standby machine and the external network element device is interrupted, and data packet transmission cannot be continued.

In another aspect, the consistency of the network protocol stack state of the standby machine and the network protocol stack state of the active machine is maintained through the transmission indication information, so that a synchronous process of the consistency is simple and easy to implement, and is applicable to numerous wide application scenes.

The foregoing general descriptions and the following detailed descriptions are merely for illustration and explanation purposes and are not intended to limit this application.

### BRIEF DESCRIPTION OF THE DRAWINGS

FIG. 1 is a schematic diagram of an exemplary implementation environment in which a technical solution according to an embodiment of this application is applicable.

FIG. 2 is a flowchart of a data packet transmission control method based on an active machine and a standby machine according to an exemplary embodiment of this application.

FIG. 3 is a flowchart of a data packet transmission control method based on an active machine and a standby machine according to another exemplary embodiment of this application.

FIG. 4 is a flowchart of a data packet transmission control method based on an active machine and a standby machine according to another exemplary embodiment of this application.

FIG. 5 is a flowchart of a data packet transmission control method based on an active machine and a standby machine according to another exemplary embodiment of this application.

FIG. 6 is a flowchart of a data packet transmission control method based on an active machine and a standby machine according to another exemplary embodiment of this application.

FIG. 7 is a flowchart of a data packet transmission control method based on an active machine and a standby machine according to another exemplary embodiment of this application.

FIG. 8 is a flowchart of a data packet transmission control method based on an active machine and a standby machine according to an exemplary embodiment of this application.

FIG. 9 is a schematic diagram of an exemplary implementation environment in which a technical solution according to an embodiment of this application is applicable.

FIG. 10 is a flowchart of a data packet transmission control method based on an active machine and a standby machine according to another exemplary embodiment of this application.

FIG. 11 is a flowchart of a data packet transmission control method based on an active machine and a standby machine according to another exemplary embodiment of this application.

FIG. 12 is a flowchart of a data packet transmission control method based on an active machine and a standby machine according to another exemplary embodiment of this application.

FIG. 13 is a flowchart of a data packet transmission control method based on an active machine and a standby machine according to another exemplary embodiment of this application.

FIG. 14 is a block diagram of a data packet transmission control apparatus based on an active machine and a standby machine according to an embodiment of this application.

FIG. 15 is a block diagram of a data packet transmission control apparatus based on an active machine and a standby machine according to an embodiment of this application.

FIG. 16 is a schematic structural diagram of a computer system adapted to implement an electronic device according to an embodiment of this application.

### DESCRIPTION OF EMBODIMENTS

Exemplary embodiments are described in detail herein, and examples thereof are shown in the accompanying drawings. When the following description involves the accompanying drawings, unless otherwise indicated, the same numerals in different accompanying drawings represent the same or similar elements. Implementations described in the following exemplary embodiments do not represent all implementations identical to this application. On the contrary, the implementations are merely examples of an apparatus and a method that are identical to some aspects of this application described in detail in the appended claims.

The block diagrams shown in the accompanying drawings are merely functional entities and do not necessarily correspond to physically independent entities. To be specific, the functional entities may be implemented in a software form, or in one or more hardware modules or integrated circuits, or in different networks and/or processor apparatuses and/or microcontroller apparatuses.

The flowcharts shown in the accompanying drawings are merely exemplary descriptions, do not need to include all content and operations/steps, and do not need to be performed in the described orders either. For example, some operations/steps may be further divided, while some operations/steps may be combined or partially combined. Therefore, an actual execution order may change according to an actual case.

“Plurality of” mentioned in this application means two or more. “And/or” describes an association relationship between associated objects and indicates that three relationships may exist. For example, A and/or B may represent the following cases: only A exists, both A and B exist, and only B exists. The character “/” generally indicates an “or” relationship between a preceding associated object and a latter associated object.

In the related art of a 5G core network, to ensure reliability of network element devices, a 1+1 active-standby scheme is usually adopted. In the scheme, one network element device serves as a primary core network element device (referred to as an active machine for short) to process a related service, and another network element device serves as a backup core network element device (referred to as a standby machine for short). When the active machine fails, the standby machine is promoted to the active machine and undertake processing of related services.

The active machine transmits a related processing message to the standby machine when processing the related services, so that the standby machine performs synchronization. However, in actual application, related processing information may be lost as a result of impact such as a network or another factor, causing a network protocol stack state of the standby machine not to be completely synchronized with a network protocol stack state of the active machine. Therefore, although the standby machine is promoted to the active machine, a connection between the standby machine and an external network element device is interrupted, and data packet transmission cannot be continued, which greatly affects normal processing of services.

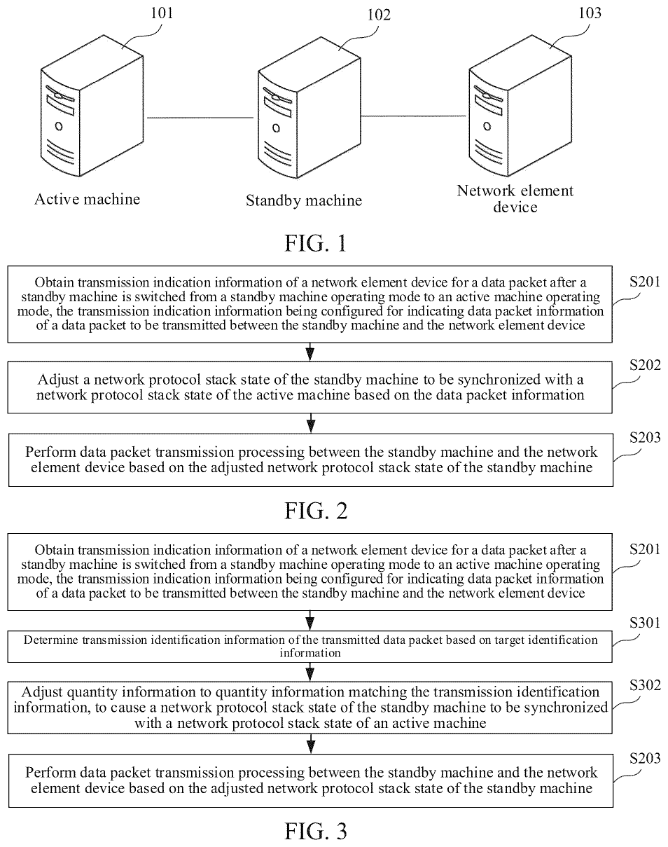

Therefore, to improve rationality of data packet transmission control based on the active machine and the standby machine and ensue normal processing of services, this application provides a data packet transmission control solution based on an active machine and a standby machine. FIG. 1 is a schematic diagram of an implementation environment involved in this application. The implementation environment mainly includes an active machine 101, a standby machine 102, and an external network element device (referred to as a network element device for short) 103. The active machine 101 and the standby machine 102 are communicatively connected to the network element device 103 through a network. The network may include various connection types, such as a wireless communications link, a wired cable, and a fiber optic cable.

Any one or more of the active machine 101, the standby machine 102, and the network element device 103 may be a switch, a router, a hub, a network interface card (NIC), a wireless access point (WAP), a modem, an optical terminal, an optical transceiver, a bridge, a server, a smart phone, a personal computer, a notebook computer, a computer, an on-board terminal, or the like. The server may be a server providing various services. The server may be an independent physical server, or may be a server cluster formed by a plurality of physical servers or a distributed system, and may further be a cloud server providing basic cloud computing services such as cloud service, a cloud database, cloud computing, a cloud function, cloud storage, a network service, cloud communication, a middleware service, a domain name service, a security service, a content delivery network (CDN), and a big data and artificial intelligence (AI) platform.

The network element device 103 includes, but is not limited to, a separately arranged network element device and a network element device arranged in a communication device. The separately arranged network element device refers to that the network element device is an independent communication device, and the network element device arranged in a communication device refers to that the network element device is a component of the communication device, for example, may be a network element device arranged in a base station.

A quantity of servers corresponding to the active machine 101, the standby machine 102, and the network element device 103 in FIG. 1 are merely exemplary. Any quantity of servers respectively corresponding to the active machine 101, the standby machine 102, and the network element device 103 may exist according to an actual need.

In an embodiment of this application, a data packet transmission control method based on an active machine and a standby machine may be interactively performed by the standby machine 102 and the network element device 103.

Exemplarily, the network element device 103 is configured to obtain a data packet to be transmitted to the standby machine 102 if it is detected that the standby machine 102 switches to an active machine operating mode; and then transmit the data packet the standby machine 102.

Correspondingly, based on the received data packet transmitted by the network element device 103, the standby machine 102 is configured to: obtain transmission indication information of the network element device 103 for the data packet, the transmission indication information being configured for indicating data packet information of a data packet to be transmitted between the standby machine 102 and the network element device 103; adjust a network protocol stack state of the standby machine 102 to be synchronized with a network protocol stack state of the active machine 101 based on the data packet information; and then transmit a corresponding data packet to the network element device 103 based on the adjusted network protocol stack state of the standby machine 102.

Correspondingly, the network element device 103 receives the data packet transmitted by the standby machine 102.

By implementing an optional embodiment, the standby machine is promoted to the active machine and continues to perform the data packet transmission with the network element device, thereby ensuring normal processing of services after switching of the active machine and the standby machine.

In an embodiment of this application, the data packet transmission control method based on an active machine and a standby machine may be interactively performed by the standby machine 102, the network element device 103, and a control device (not shown in FIG. 1).

Exemplarily, after the standby machine 102 switches from a standby machine operating mode to the active machine operating mode, the control device is configured to: obtain transmission indication information of the network element device 103 for the data packet, the transmission indication information being configured for indicating data packet information of a data packet to be transmitted between the standby machine 102 and the network element device 103; adjust a network protocol stack state of the standby machine 102 to be synchronized with a network protocol stack state of the active machine 101 based on the data packet information; and then control data packet transmission processing between the standby machine 102 and the network element device 103 based on the adjusted network protocol stack state of the standby machine 102.

Correspondingly, the standby machine 102 is configured to adjust the network protocol stack state of the standby machine 102 to be synchronized with a network protocol stack state of the active machine 101 based on a received control instruction transmitted by the control device, and then transmit a corresponding data packet to the network element device 103 based on the adjusted network protocol stack state of the standby machine 102.

Correspondingly, the network element device 103 receives the data packet transmitted by the standby machine 102.

The control device may be a device configured to manage the active machine and the standby machine, for example, a cloud controller. In a practical application, an adjustment may be flexibly made based on a specific application scene.

By implementing an optional embodiment, the standby machine is promoted to the active machine and continues to perform the data packet transmission with the network element device, thereby ensuring normal processing of services after switching of the active machine and the standby machine.

The technical solution of the embodiment shown in FIG. 1 may be applied to various virtual scenes, including but not limited to, intelligent transportation, auxiliary driving, a cloud technology, AI, and the like. In a practical application, an adjustment may be correspondingly made based on a specific application scene.

Exemplarily, if the technical solution is applied to the scene of intelligent traffic or auxiliary driving, the service may be a service of vehicle to everything, and correspondingly, the active machine/standby machine may be a network element device processing the service of vehicle to everything. Further, by implementing the technical solution of this embodiment of this application, data packet transmission control based on the active machine and the standby machine is more reasonable, and normal processing of the service of vehicle to everything is ensured.

Exemplarily, if the technical solution is applied to the scene of cloud technology or AI, the service may be a cloud game service, and correspondingly, the active machine/standby machine may be a network element device for processing the cloud game service. Further, by implementing the technical solution of this embodiment of this application, data packet transmission control based on the active machine and the standby machine is more reasonable, and normal processing of the cloud game service is ensured.

In a specific implementation of this application, user-related data is involved. When the embodiments of this application are applied to a specific product or technology, permission or consent of an object needs to be obtained, and acquisition, use, and processing of the relevant data need to comply with relevant laws, regulations, and standards of relevant countries and regions.

Various implementation details of the technical solutions of the embodiments of this application are described below in detail.

FIG. 2 is a flowchart of a data packet transmission control method based on an active machine and a standby machine according to an embodiment of this application. The data packet transmission control method based on an active machine and a standby machine may be performed by a standby machine 102. As shown in FIG. 2, the data packet transmission control method based on an active machine and a standby machine includes at least S201 to S203. A detailed description is as follows.

S201: Obtain transmission indication information from a network element device for a data packet after a standby machine switches from a standby machine operating mode to an active machine operating mode, the transmission indication information being configured for indicating data packet information of a data packet to be transmitted between the standby machine and the network element device.

In this embodiment of this application, the standby machine operating mode refers to an operation mode where the standby machine is in before being promoted to an active machine. Correspondingly, the active machine operating mode refers to an operation mode where the standby machine is in after being promoted to the active machine.

After the standby machine is promoted to the active machine, the standby machine needs to perform data packet transmission with the network element device in place of the active machine, to ensure normal processing of services. Therefore, in this embodiment of this application, if it is detected that the standby machine is promoted to the active machine (i.e., switched from the standby machine operating mode to the active machine operating mode), the standby machine may obtain the transmission indication information of the network element device for the data packet.

In this embodiment of this application, the transmission indication information is data packet information configured for indicating a data packet to be transmitted between the standby machine and the network element device. The data packet information refers to information related to the data packet to be transmitted, including, but not limited to, identification information of the data packet, protocol information followed, and the like.

Exemplarily, the transmission indication information may include packet transmission indication information, and the data packet information may include target identification information. The packet transmission indication information is configured for indicating target identification information corresponding to a data packet to be transmitted by the standby machine.

For example, it is assumed that target identification information is M+1, i.e., the packet transmission indication information is configured for indicating that the standby machine needs to transmit a data packet to the network element device, and target identification information of the data packet to be transmitted is M+1. In short, the standby machine needs to transmit an (M+1)th data packet to the network element device.

Exemplarily, the transmission indication information may include packet reception indication information, and the data packet information may include target identification information. The packet reception indication information is configured for indicating target identification information corresponding to a data packet to be received by the standby machine.

For example, it is assumed that target identification information is N+1, i.e., the packet reception indication information is configured for indicating that the standby machine needs to receive a data packet transmitted by the network element device, and target identification information of the data packet to be received is N+1. In short, the standby machine needs to receive an (N+1)^{th} data packet transmitted by the network element device.

S202: Adjust a network protocol stack state of the standby machine to be synchronized with a network protocol stack state of the active machine based on the data packet information.

After the standby machine is promoted to the active machine, the standby machine mainly performs data packet transmission with the network element device in place of the active machine based on the network protocol stack state of the standby machine. Therefore, in this embodiment of this application, the standby machine obtains the transmission indication information for the data packet transmitted by the network element device, and needs to adjust the network protocol stack state of the standby machine based on the data packet information of the data packet to be transmitted between the standby machine and the network element device indicated by the transmission indication information. In addition, since the transmission indication information for the data packet transmitted by the network element device is consistent with the network protocol stack state of the active machine, the network protocol stack state of the standby machine may be adjusted to be synchronized with the network protocol stack state of the active machine based on the data packet information of the data packet to be transmitted between the standby machine and the network element device indicated by the transmission indication information.

In other words, only when the network protocol stack state of the standby machine is synchronized with the network protocol stack state of the active machine, the standby machine may successfully perform data packet transmission with the network element device in place of the active machine by virtue of the network protocol stack state of the standby machine that is synchronized with the network protocol stack state of the active machine. On the contrary, if the network protocol stack state of the standby machine is not synchronized with the network protocol stack state of the active machine, the standby machine cannot successfully perform data packet transmission with the network element device in place of the active machine by virtue of the network protocol stack state of the standby machine that is not synchronized with the network protocol stack state of the active machine.

S203: Perform data packet transmission processing between the standby machine and the network element device based on the adjusted network protocol stack state of the standby machine.

In this embodiment of this application, the standby machine adjusts the network protocol stack state of the standby machine to be synchronized with the network protocol stack state of the active machine, and then may successfully perform data packet transmission with the network element device in place of the active machine based on the adjusted network protocol stack state of the standby machine synchronized with the network protocol stack state of the active machine, to ensure that the standby machine is normally connected to the network element device, so that a service can be normally processed.

In this embodiment of this application, the standby machine maintains consistency of the network protocol stack state of the standby machine and the network protocol stack state of the active machine through the transmission indication information, so that data packet transmission may be performed between the standby machine and the network element device, thereby improving rationality of data packet transmission control of the active machine and the standby machine, and ensuring normal processing of services after switching of the active machine and the standby machine. In addition, the consistency of the network protocol stack state of the standby machine and the network protocol stack state of the active machine is maintained through the transmission indication information, so that a synchronous process of the consistency is simple and easy to implement, and is applicable to numerous wide application scenes.

In an embodiment of this application, another data packet transmission control method based on an active machine and a standby machine is provided. The data packet transmission control method based on an active machine and a standby machine may be performed by the standby machine 102. As shown in FIG. 3, the data packet transmission control method based on an active machine and a standby machine may include S301, S302, S201, and S203.

In this embodiment of this application, the data packet information includes target identification information, and the target identification information is identification information of a data packet to be transmitted between the standby machine and the network element device. The identification information is configured for uniquely identifying a data packet, and the identification information includes, but is not limited to, a data packet sequence number, a data packet name, and the like.

In this embodiment of this application, the network protocol stack state of the standby machine includes quantity information corresponding to transmitted data packets between the active machine and the network element device.

Exemplarily, the transmitted data packet may be a data packet that has been transmitted to the network element device by the active machine. In other words, the quantity information is configured for characterizing a packet transmission quantity corresponding to the data packets that have been transmitted by the active machine to the network element device, as is the case when the active machine transmits a data packet to the network element device.

For example, for a case when the active machine transmits the data packet to the network element device, the quantity information corresponds to the packet transmission quantity. It is assumed that the network protocol stack state of the standby machine includes that the active machine has transmitted M-Y data packets to the network element device. In other words, the packet transmission quantity is M-Y.

Exemplarily, the transmitted data packet may be a transmitted data packet for the network element device received by the active machine. In other words, the quantity information is configured for characterizing a packet reception quantity corresponding to the transmitted data packet for the network element device received by the active machine, as is the case when the active machine receives a data packet transmitted by the network element device.

For example, when the active machine receives the data packet transmitted by the network element device, the quantity information corresponds to the packet reception quantity. It is assumed that the network protocol stack state of the standby machine includes that the active machine has received N−X data packets transmitted by the network element device. In other words, the packet reception quantity is N−X.

A detailed description of S301 and S302 is as follows.

S301: Determine transmission identification information of the transmitted data packet based on the target identification information.

In this embodiment of this application, the standby machine obtains the transmission indication information for the data packet that is transmitted by the network element device, and then may determine the transmission identification information of the transmitted data packet based on the target identification information of the data packet to be transmitted between the standby machine and the network element device indicated by the transmission indication information.

In this embodiment of this application, the transmission identification information refers to identification information corresponding to the transmitted data packet. The identification information is configured for uniquely identifying a data packet, and the identification information includes, but is not limited to, a data packet sequence number, a data packet name, and the like.

In an embodiment of this application, for a case when the standby machine transmits the data packet to the network element device, the transmission indication information may include packet transmission indication information for indicating target identification information corresponding to a data packet to be transmitted by the standby machine, the target identification information including first identification information, and the quantity information being configured for characterizing a packet transmission quantity corresponding to data packets that have been transmitted by the active machine to the network element device.

In an optional embodiment, the target identification information of the data packet which needs to be transmitted by the standby machine to the network element device is referred to as the first identification information, so as to be distinguished from the second identification information of the data packet which needs to be received by the standby machine from the network element device. The packet transmission indication information and the packet transmission quantity are described in the foregoing embodiments, and details are not described herein again.

Correspondingly, in S301, the process of determining transmission identification information of the transmitted data packet based on the target identification information may include:

using previous identification information adjacent to the target identification information as transmission identification information of the transmitted data packet.

In other words, in an optional embodiment, for a case when the standby machine transmits the data packet to the network element device, the previous identification information adjacent to the target identification information is used as the transmission identification information of the transmitted data packet.

For example, it is assumed that the target identification information of the data packet that needs to be transmitted by the standby machine to the network element device indicated by the packet transmission indication information is M+1, and that previous identification information adjacent to the M+1 is calculated as M, in this case, the previous identification information M adjacent to the M+1 is used as the transmission identification information of the transmitted data packet.

In an embodiment of this application, for a case when the standby machine receives the data packet transmitted by the network element device, the transmission indication information includes packet reception indication information for indicating the target identification information corresponding to the data packet that the standby machine needs to receive. The target identification information includes the second identification information. The quantity information is configured for characterizing that the standby machine has received the packet reception quantity corresponding to the data packet transmitted by the network element device.

In an optional embodiment, the target identification information of the data packet which needs to be received by the standby machine from the network element device is referred to as the second identification information, so as to be distinguished from the first identification information of the data packet which needs to be transmitted by the standby machine to the network element device. The packet reception indication information and the packet reception quantity are described in the foregoing embodiments, and details are not described herein again.

Correspondingly, in S301, the process of determining transmission identification information of the transmitted data packet based on the target identification information may include:
using previous identification information adjacent to the target identification information as receiving identification information of the received data packet.

In other words, in an optional embodiment, for a case when the standby machine receives the data packet transmitted by the network element device, the previous identification information adjacent to the target identification information is used as the receiving identification information of the received data packet.

For example, it is assumed that the target identification information that the standby machine indicated by the packet reception indication information needs to receive the data packet transmitted by the network element device is N+1, and that previous identification information adjacent to N+1 is calculated as N, in this case, the previous identification information N adjacent to the target identification information N+1 is used as the receiving identification information of the received data packet.

S302: Adjust the quantity information to quantity information matching the transmission identification information, to cause the network protocol stack state of the standby machine to be synchronized with the network protocol stack state of the active machine.

In this embodiment of this application, the standby machine determines the transmission identification information of the transmitted data packet based on the target identification information, and then may adjust the quantity information to the quantity information matching the transmission identification information, so that the network protocol stack state of the standby machine is synchronized with the network protocol stack state of the active machine.

In an embodiment of this application, for a case when the standby machine transmits the data packet to the network element device, the process of adjusting the quantity information to quantity information matching the transmission identification information in S302 may include:
adjusting the packet transmission quantity to a packet transmission quantity matching the transmission identification information.

In other words, in an optional embodiment, for a case when the standby machine transmits the data packet to the network element device, the packet transmission quantity is adjusted to the packet transmission quantity matching the previous identification information adjacent to the first identification information, so that the packet transmission quantity included in the network protocol stack state of the standby machine is synchronized with the packet transmission quantity included in the network protocol stack state of the active machine.

For example, following the foregoing example in which the standby machine transmits the data packet to the network element device, the packet transmission quantity is M-Y, and the first identification information is M+1. In this case, the packet transmission quantity M-Y is adjusted to the previous identification information M adjacent to M+1. In other words, the packet transmission quantity is adjusted from M-Y to M.

In an embodiment of this application, for a case when the standby machine receives the data packet transmitted by the network element device, the process of adjusting the quantity information to quantity information matching the transmission identification information in S302 may include:
adjusting the packet reception quantity to a packet reception quantity matching the receiving identification information.

In other words, in an optional embodiment, for a case when the standby machine receives the data packet transmitted by the network element device, the packet reception quantity is adjusted to the packet reception quantity matching the second identification information, so that the packet reception quantity included in the network protocol stack state of the standby machine is synchronized with the packet reception quantity included in the network protocol stack state of the active machine.

For example, following the foregoing example in which the standby machine receives the data packet transmitted by the network element device, the packet reception quantity is N−X, and the second identification information is N+1. In this case, the packet reception quantity N−X is adjusted to the previous identification information N adjacent to the second identification information N+1. In other words, the packet reception quantity is adjusted from N−X to N.

For a detailed description of S201 and S203 shown in FIG. 3, reference is made to S201 and S203 shown in FIG. 2. Details are not described herein again.

In this embodiment of this application, the standby machine may quickly and conveniently adjust, based on the target identification information of the data packet to be transmitted between the standby machine and the network element device indicated by the transmission indication information, the quantity information corresponding to transmitted data packets between the active machine and the network element device included in the network protocol stack state of the standby machine, thereby maintaining consistency of the network protocol stack state of the standby machine and the network protocol stack state of the active machine.

In an embodiment of this application, another data packet transmission control method based on an active machine and a standby machine is provided. The data packet transmission control method based on an active machine and a standby machine may be performed by the standby machine 102. As shown in FIG. 4, the data packet transmission control method based on an active machine and a standby machine may include S401, S402, S201, and S203.

In this embodiment of this application, the data packet information includes target identification information, and the target identification information is identification information of a data packet to be transmitted between the standby machine and the network element device. The identification information is configured for uniquely identifying a data packet, and the identification information includes, but is not limited to, a data packet sequence number, a data packet name, and the like.

In this embodiment of this application, the network protocol stack state of the standby machine includes quantity information corresponding to transmitted data packets between the active machine and the network element device.

Exemplarily, the transmitted data packet may be a data packet that has been transmitted to the network element device by the active machine. In other words, the quantity information is configured for characterizing a packet transmission quantity corresponding to the data packets that have been transmitted by the active machine to the network element device, as is the case when the active machine transmits a data packet to the network element device.

For example, for a case when the active machine transmits the data packet to the network element device, the quantity information corresponds to the packet transmission quantity. It is assumed that the network protocol stack state of the standby machine includes that the active machine has transmitted M-Y data packets to the network element device. In other words, the packet transmission quantity is M-Y.

Exemplarily, the transmitted data packet may be a transmitted data packet for the network element device received by the active machine. In other words, the quantity information is configured for characterizing a packet reception quantity corresponding to the transmitted data packet for the network element device received by the active machine, as is the case when the active machine receives a data packet transmitted by the network element device.

For example, when the active machine receives the data packet transmitted by the network element device, the quantity information corresponds to the packet reception quantity. It is assumed that the network protocol stack state of the standby machine includes that the active machine has received N−X data packets transmitted by the network element device. In other words, the packet reception quantity is N−X.

A detailed description of S401 and S402 is as follows.

S401: Detect a synchronization status between the network protocol stack state of the standby machine and the network protocol stack state of the active machine based on a relationship between the target identification information and the quantity information.

In this embodiment of this application, the standby machine obtains the transmission indication information for the data packet that is transmitted by the network element device, and then may detect the synchronization status between the network protocol stack state of the standby machine and the network protocol stack state of the active machine based on a relationship between the target identification information and the quantity information of the data packet to be transmitted between the standby machine and the network element device indicated by the transmission indication information, and further determine whether to perform adjustment processing based on the detected synchronous status.

In an embodiment of this application, the process of detecting a synchronization status between the network protocol stack state of the standby machine and the network protocol stack state of the active machine based on a relationship between the target identification information and the quantity information in S401 may include:
determining third identification information corresponding to a to-be-transmitted data packet based on the quantity information;
obtaining a detection result for characterizing that the network protocol stack state of the standby machine is not completely synchronized with the network protocol stack state of the active machine if the target identification information does not match the third identification information; and
obtaining a detection result for characterizing that the network protocol stack state of the standby machine is completely synchronized with the network protocol stack state of the active machine if the target identification information matches the third identification information.

In other words, in an optional embodiment, the standby machine may determine third identification information corresponding to a to-be-transmitted data packet based on the quantity information, and then detect the synchronization status between the network protocol stack state of the standby machine and the network protocol stack state of the active machine based on the relationship between the target identification information and the third identification information.

In an optional embodiment, the to-be-transmitted data packet may be a data packet that needs to be transmitted to the network element device for the standby machine, or may be a data packet transmitted from the network element device that the standby machine needs to receive.

In an optional embodiment, the third identification information is identification information corresponding to the to-be-transmitted data packet determined based on the quantity information, which is to be distinguished from the first identification information and the second identification information in the foregoing embodiment.

In an optional embodiment, that the synchronization status between the network protocol stack state of the standby machine and the network protocol stack state of the active machine is detected based on the relationship between the target identification information and the third identification information includes the following two cases.

Case I: If the target identification information does not match the third identification information, a detection result for characterizing that the network protocol stack state of the standby machine is not completely synchronized with the network protocol stack state of the active machine is obtained. In other words, if the target identification information does not match the third identification information, it is detected that the network protocol stack state of the standby machine is not completely synchronized with the network protocol stack state of the active machine in this case.

For example, in a case where the standby machine transmits the data packet to the network element device, the quantity information is a packet transmission quantity, and the target identification information is the first identification information in this case. It is assumed that the packet transmission quantity is M−Y, next adjacent identification information M−Y+1 of the packet transmission quantity M−Y is determined as third identification information M−Y+1 corresponding to a to-be-transmitted data packet. In addition, it is assumed that the first identification information is M+1. Apparently, the first identification information M+1 does not match the third identification information M−Y+1. In this case, a detection result for characterizing that the packet transmission quantity included in the network protocol stack state of the standby machine is not completely synchronized with the packet transmission quantity included in the network protocol stack state of the active machine is obtained.

For another example, in a case where the standby machine receives the data packet transmitted by the network element device, the quantity information is a packet reception quantity, and the target identification information is second identification information in this case. It is assumed that the packet reception quantity is N−X, next adjacent identification information N−X+1 of the packet reception quantity N−X is determined as third identification information N−X+1 corresponding to a to-be-received data packet. In addition, it is assumed that the second identification information is N+1. Apparently, the second identification information N+1 does not match the third identification information N−X+1. In this case, a detection result for characterizing that the packet reception quantity included in the network protocol stack state of the standby machine is not completely synchronized with the packet reception quantity included in the network protocol stack state of the active machine is obtained.

Case II: If the target identification information matches the third identification information, a detection result for characterizing that the network protocol stack state of the standby machine is completely synchronized with the network protocol stack state of the active machine is obtained. In other words, if the target identification information matches the third identification information, it is detected that the network protocol stack state of the standby machine is completely synchronized with the network protocol stack state of the active machine in this case.

For example, in a case where the standby machine transmits the data packet to the network element device, the quantity information is a packet transmission quantity, and the target identification information is the first identification information in this case. It is assumed that the packet transmission quantity is M, next adjacent identification information M+1 of the packet transmission quantity M is determined as third identification information M+1 corresponding to a to-be-transmitted data packet. In addition, it is assumed that the first identification information is M+1. Apparently, the first identification information M+1 matches the third identification information M+1. In this case, a detection result for characterizing that the packet transmission quantity included in the network protocol stack state of the standby machine is completely synchronized with the packet transmission quantity included in the network protocol stack state of the active machine is obtained.

For another example, in a case where the standby machine receives the data packet transmitted by the network element device, the quantity information is a packet reception quantity, and the target identification information is second identification information in this case. It is assumed that the packet reception quantity is N, next adjacent identification information N+1 of the packet reception quantity N is determined as third identification information N+1 corresponding to a to-be-received data packet. In addition, it is assumed that the second identification information is N+1. Apparently, the second identification information N+1 matches the third identification information N+1. In this case, a detection result for characterizing that the packet reception quantity included in the network protocol stack state of the standby machine is completely synchronized with the packet reception quantity included in the network protocol stack state of the active machine is obtained.

S402: Adjust the network protocol stack state of the standby machine to be synchronized with the network protocol stack state of the active machine based on the target identification information if the synchronization status characterizes that the network protocol stack state of the standby machine is not completely synchronized with the network protocol stack state of the active machine.

In this embodiment of this application, for the foregoing Case I, if the synchronization status characterizes that the network protocol stack state of the standby machine is not completely synchronized with the network protocol stack state of the active machine, the network protocol stack state of the standby machine may be adjusted to be synchronized with the network protocol stack state of the active machine based on the target identification information.

Exemplarily, for a case when the standby machine transmits the data packet to the network element device, the quantity information is the packet transmission quantity, and the target identification information is the first identification information in this case. The packet transmission quantity included in the network protocol stack state of the standby machine may be adjusted to be synchronized with the packet transmission quantity included in the network protocol stack state of the active machine based on the first identification information.

Exemplarily, for a case when the standby machine receives the data packet transmitted by the network element device, the quantity information is the packet reception quantity, and the target identification information is the second identification information in this case. The packet reception quantity included in the network protocol stack state of the standby machine may be adjusted to be synchronized with the packet reception quantity included in the network protocol stack state of the active machine based on the second identification information.

In this embodiment of this application, for the foregoing Case II, if the synchronization status characterizes that the network protocol stack state of the standby machine is completely synchronized with the network protocol stack state of the active machine, no processing may be performed.

Exemplarily, for a case when the standby machine transmits the data packet to the network element device, the packet transmission quantity included in the network protocol stack state of the standby machine is completely synchronized with the packet transmission quantity included in the network protocol stack state of the active machine in this case. The packet transmission quantity included in the network protocol stack state of the standby machine does not need to be adjusted to be synchronized with the packet transmission quantity included in the network protocol stack state of the active machine based on the target identification information.

Exemplarily, for a case when the standby machine receives the data packet transmitted by the network element device, the packet reception quantity included in the network protocol stack state of the standby machine is completely synchronized with the packet reception quantity included in the network protocol stack state of the active machine in this case. The packet reception quantity included in the network protocol stack state of the standby machine does not need to be adjusted to be synchronized with the packet reception quantity included in the network protocol stack state of the active machine based on the target identification information.

For a detailed description of S201 and S203 shown in FIG. 4, reference is made to S201 and S203 shown in FIG. 2. Details are not described herein again.

In this embodiment of this application, after it is detected that the network protocol stack state of the standby machine is not completely synchronized with the network protocol stack state of the active machine based on the target identification information of the data packet to be transmitted between the standby machine and the network element device indicated by the transmission indication information, the standby machine adjusts the network protocol stack state of the standby machine to be synchronized with the network protocol stack state of the active machine based on the target identification information, thereby avoiding unnecessary complex adjustment operations and saving specific adjustment resources.

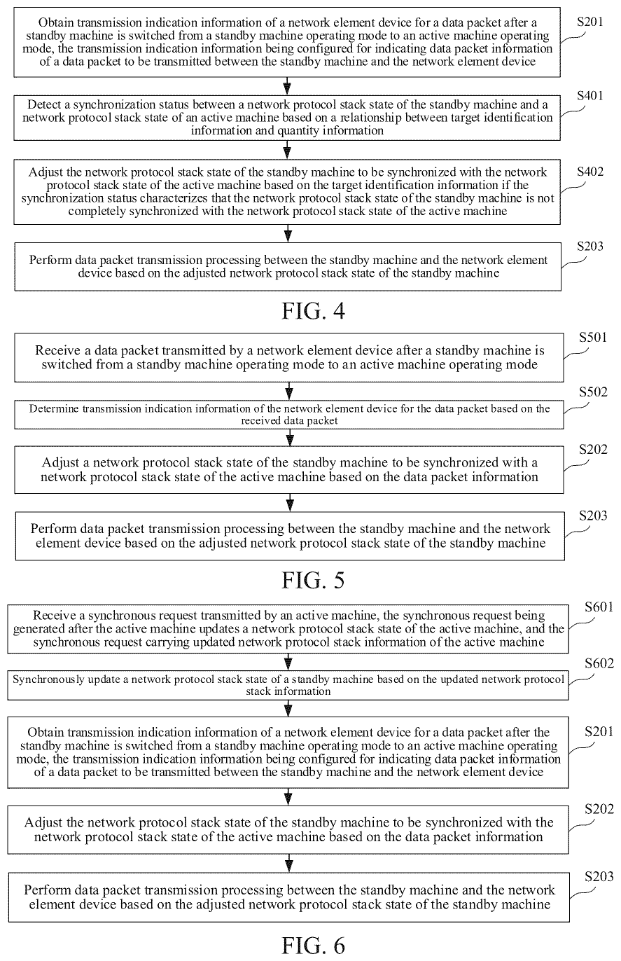

In an embodiment of this application, another data packet transmission control method based on an active machine and a standby machine is provided. The data packet transmission control method based on an active machine and a standby machine may be performed by the standby machine 102. As shown in FIG. 5, the data packet transmission control method based on an active machine and a standby machine may include S501, S502, S202, and S203.

A detailed description of S501 and S502 is as follows.

S501: Receive a data packet transmitted by the network element device.

In this embodiment of this application, the network element device may send the data packet to a standby machine. Correspondingly, the standby machine receives the data packet transmitted by the network element device.

In an embodiment of this application, as a case when the standby machine transmits the data packet to the network element device, the process of receiving a data packet transmitted by the network element device in S501 may include:
transmitting a data packet with specified identification information to the network element device based on the network protocol stack state of the standby machine; and
receiving a data packet fed back by the network element device based on the data packet with the specified identification information.

In other words, in an optional embodiment, for a case when the standby machine transmits the data packet to the network element device, the standby machine may transmit a data packet with specified identification information to the network element device based on a packet transmission quantity included in the network protocol stack state of the standby machine. Correspondingly, the network element device receives the data packet with the specified identification information transmitted by the standby machine, and then may transmit feedback data packet to the standby machine when it is detected that the data packet with the specified identification information transmitted by the standby machine is not a correct data packet currently needed. Correspondingly, the standby machine receives feedback data packet transmitted by the network element device.

In an optional embodiment, the transmitting a data packet with specified identification information to the network element device based on the network protocol stack state of the standby machine may include:
determining third identification information corresponding to a to-be-transmitted data packet based on the packet transmission quantity included in the network protocol stack state of the standby machine, and using the determined third identification information as the specified identification information; and
transmitting the data packet with the specified identification information to the network element device.

In other words, in an optional embodiment, the standby machine may determine the third identification information corresponding to the to-be-transmitted data packet based on a packet transmission quantity included in the network protocol stack state of the standby machine, use the determined third identification information as the specified identification information, and then transmit the data packet with the specified identification information to the network element device.

In an optional embodiment, the third identification information refers to identification information corresponding to the to-be-transmitted data packet determined based on the quantity information, i.e., the third identification information in the foregoing embodiment, which is to be distinguished from the first identification information and the second identification information in the foregoing embodiment.

For example, it is assumed that the packet transmission quantity is M−Y, the specified identification information is M−Y+1. In this case, the standby machine transmits an (M−Y+1)^{th} data packet to the network element device. Correspondingly, the network element device receives the (M−Y+1)^{th} data packet transmitted by the standby machine. In addition, it is assumed that an actual situation is that the network element device receives M data packets transmitted by the active machine, and what is needed is an (M+1)^{th} data packet. Therefore, the network element device determines that the (M−Y+1)^{th} data packet transmitted by the standby machine is not the correct data packet currently needed, generates the (M+1)^{th} data packet (i.e., the feedback data packet, data content of the feedback data packet including the first identification information M+1 but not including content actually needed by the network element device to perform service processing), and transmits the (M+1)^{th} data packet to the standby machine. Correspondingly, the standby machine receives the (M+1)^{th} data packet transmitted by the network element device, so that it can be determined that the correct data packet currently needed by the network element device is the (M+1)^{th} data packet, and then the (M+1)^{th} data packet (data content of the data packet includes content actually needed by the network element device to perform service processing) is transmitted to the network element device.

In an embodiment of this application, for a case when the standby machine receives the data packet transmitted by the network element device, the network element device transmits the correct data packet currently needed to the standby machine. Correspondingly, the standby machine receives the data packet transmitted by the network element device.

In other words, in an optional embodiment, for a case when the standby machine receives the data packet transmitted by the network element device, the standby machine does not need to transmit the data packet with the specified identification information to the network element device based on the packet transmission quantity included in the network protocol stack state of the standby machine, but only needs to receive the data packet transmitted by the network element device.

For example, assuming that an actual situation is that the network element device has transmitted N data packets to the active machine, the network element device generates an (N+1)^{th} data packet, and transmits the (N+1)^{th} data packet to the standby machine. Correspondingly, the standby machine receives the (N+1)^{th} data packet transmitted by the network element device, so as to determine that the correct data packet currently needed by the standby machine is the (N+1)^{th} data packet and receive the (N+1)^{th} data packet.

S502: Determine the transmission indication information of the network element device for the data packet based on the received data packet.

In this embodiment of this application, the standby machine receives the data packet transmitted by the network element device, and then may determine the transmission indication information of the network element device for the data packet based on the received data packet, so as to obtain the transmission indication information of the network element device for the data packet.

In an embodiment of this application, for a case when the standby machine transmits the data packet to the network element device, the process of determining the transmission indication information of the network element device for the data packet based on the received data packet in S502 may include:
determining packet transmission indication information of the standby machine for the data packet based on data packet information corresponding to the received data packet, the packet transmission indication information being configured for indicating data packet information of a data packet to be transmitted by the standby machine; and
using the packet transmission indication information as the transmission indication information.

In other words, in an optional embodiment, for a case when the standby machine transmits the data packet to the network element device, the standby machine receives the data packet transmitted by the network element device, and then may determine the packet transmission indication information of the standby machine for the data packet based on the data packet information corresponding to the received data packet. In this case, the determined packet transmission indication information is the transmission indication information.

For example, following the foregoing example in which the standby machine transmits the data packet to the network element device, if the standby machine receives the (M+1)^{th} data packet, i.e., the data packet information of the (M+1)^{th} data packet is M+1, packet transmission indication information configured for characterizing an indication that the standby machine needs to transmit the (M+1)^{th} data packet to the network element device is obtained.

In an embodiment of this application, for a case when the standby machine receives the data packet transmitted by the network element device, the process of determining the transmission indication information of the network element device for the data packet based on the received data packet in S502 may include:
determining packet reception indication information of the standby machine for the data packet based on data packet information corresponding to the received data packet, the packet reception indication information being configured for indicating data packet information of a data packet to be received by the standby machine; and
using the packet reception indication information as the transmission indication information.

In other words, in an optional embodiment, for a case when the standby machine receives the data packet transmitted by the network element device, the standby machine receives the data packet transmitted by the network element device, and then may determine the packet reception indication information of the standby machine for the data packet based on the data packet information corresponding to the received data packet. In this case, the determined packet reception indication information is the transmission indication information.

For example, following the foregoing example in which the standby machine receives the data packet transmitted by the network element device, the (N+1)^{th} data packet is received by the standby machine, i.e., the data packet information of the (N+1)^{th} data packet is N+1, so that the packet reception indication information configured for characterizing an indication that the standby machine needs to receive the (N+1)^{th} data packet transmitted by the network element device is obtained.

For a detailed description of S202 and S203 shown in FIG. 5, reference is made to S202 and S203 shown in FIG. 2. Details are not described herein again.

In this embodiment of this application, based on the received data packet transmitted by the network element device, the standby machine may quickly and conveniently determine the transmission indication information of the network element device for the data packet, thereby providing strong support for subsequent synchronous adjustment of the network protocol stack state of the standby machine and the network protocol stack state of the active machine.

In an embodiment of this application, another data packet transmission control method based on an active machine and a standby machine is provided. The data packet transmission control method based on an active machine and a standby machine may be performed by the standby machine 102. As shown in FIG. 6, the data packet transmission control method based on an active machine and a standby machine may further include S601 and S602 before S201.

A detailed description of S601 and S602 is as follows.

S601: Receive a synchronous request transmitted by the active machine, the synchronous request being generated after the active machine updates a network protocol stack state of the active machine, and the synchronous request carrying updated network protocol stack information of the active machine.

In this embodiment of this application, after updating the network protocol stack state of the active machine, the active machine may obtain the updated network protocol stack information of the active machine, generate the synchronous request based on the updated network protocol stack information of the active machine, and transmit the synchronous request to the standby machine. Correspondingly, the standby machine receives the synchronous request transmitted by the active machine.

S602: Synchronously update a network protocol stack state of the standby machine based on the updated network protocol stack information.

In this embodiment of this application, after receiving the synchronous request transmitted by the active machine, the standby machine may synchronously update the network protocol stack state of the standby machine based on the updated network protocol stack information carried in the synchronous request.

In an embodiment of this application, the process of synchronously updating the network protocol stack state of the standby machine based on the updated network protocol stack information in S602 may include: synchronously updating a packet transmission quantity included in the network protocol stack state of the standby machine based on the updated network protocol stack information if the updated network protocol stack information is for a case when the active machine transmits a data packet to the network element device, to cause the packet transmission quantity included in the network protocol stack state of the standby machine to be synchronized with a packet transmission quantity included in the network protocol stack state of the active machine.

Exemplarily, if the updated network protocol stack information is for a case when the active machine transmits the data packet to the network element device, the packet transmission quantity included in the network protocol stack state of the standby machine is synchronously updated based on the updated network protocol stack information in this case, to cause the packet transmission quantity included in the network protocol stack state of the standby machine to be synchronized with the packet transmission quantity included in the network protocol stack state of the active machine.

In an embodiment of this application, the process of synchronously updating the network protocol stack state of the standby machine based on the updated network protocol stack information in S602 may include: synchronously updating a packet reception quantity included in the network protocol stack state of the standby machine based on the updated network protocol stack information if the updated network protocol stack information is for a case when the active machine receives a data packet transmitted by the network element device, to cause the packet reception quantity included in the network protocol stack state of the standby machine to be synchronized with a packet reception quantity included in the network protocol stack state of the active machine.

Exemplarily, if the updated network protocol stack information is for a case when the active machine receives the data packet transmitted by the network element device, the packet reception quantity included in the network protocol stack state of the standby machine is synchronously updated based on the updated network protocol stack information in this case, to cause the packet reception quantity included in the network protocol stack state of the standby machine to be synchronized with the packet reception quantity included in the network protocol stack state of the active machine.

In an embodiment of this application, the process of synchronously updating the network protocol stack state of the standby machine based on the updated network protocol stack information in S602 may include:
synchronously updating the network protocol stack state of the standby machine based on the updated network protocol stack information through a negative acknowledgment mechanism, the negative acknowledgment mechanism being configured for characterizing that the standby machine does not need to transmit a synchronous update result to the active machine after completing the synchronous update.

In other words, in an optional embodiment, the standby machine synchronously updates the network protocol stack state of the standby machine based on the updated network protocol stack information, and does not need to transmit the synchronous update result to the active machine after completing the synchronous update. In short, no matter whether the synchronous update is completed successfully or fails, the standby machine does not need to feed back the synchronous update to the active machine.

As described in the foregoing embodiments, in the solutions of the embodiments of this application, when network protocol states of the active machine and the standby machine are inconsistent, the standby machine is promoted to the active device and then can continue to perform the data packet transmission with the network element device. Therefore, in an optional embodiment, the network protocol stack state of the standby machine may be updated through the negative acknowledgment mechanism. Even if the synchronous update of the network protocol stack state of the standby machine fails, the data packet transmission between the standby machine and the network element device is not affected, so as to save a specific acknowledgment resource and improve efficiency of synchronously updating the network protocol stack state of the standby machine.

For a detailed description of S201 to S203 shown in FIG. 6, reference is made to S201 to S203 shown in FIG. 2. Details are not described herein again.

In this embodiment of this application, the standby machine synchronously updates the network protocol stack state of the standby machine in real time based on the updated network protocol stack information of the active machine, which provides strong support for subsequent promotion of the standby machine to the active machine. In addition, the standby machine synchronously updates the network protocol stack state of the standby machine through the negative acknowledgment mechanism, which saves a specific acknowledgment resource and improves the efficiency of synchronously updating the network protocol stack state of the standby machine.

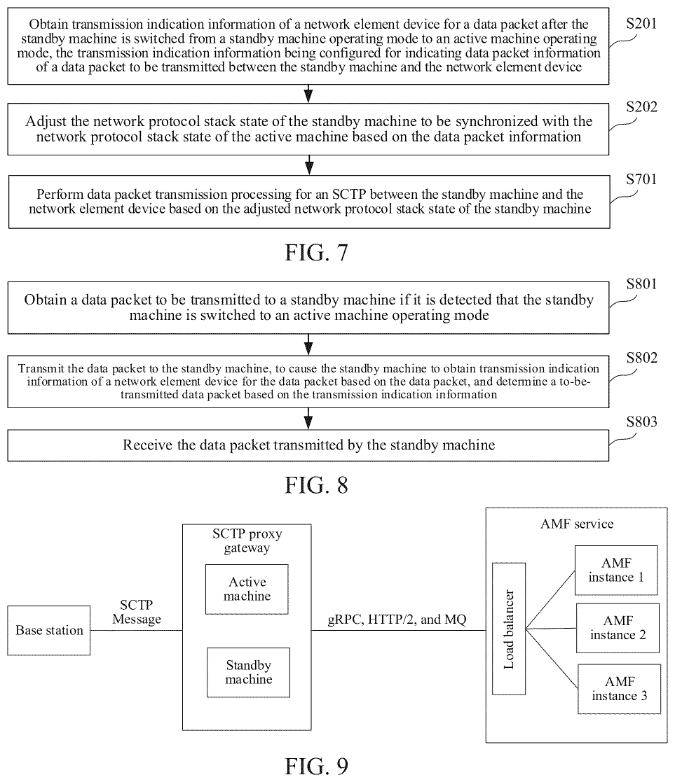

In an embodiment of this application, another data packet transmission control method based on an active machine and a standby machine is provided. The data packet transmission control method based on an active machine and a standby machine may be performed by the standby machine 102. As shown in FIG. 7, the data packet transmission control method based on an active machine and a standby machine may include S701, S201, and S202.

In this embodiment of this application, the network element device includes at least one of a separately arranged network element device and a network element device arranged in a base station.

A detailed description of S701 is as follows.

S701: Perform data packet transmission processing for a stream control transmission protocol (SCTP) between the standby machine and the network element device based on the adjusted network protocol stack state of the standby machine.

In this embodiment of this application, the standby machine adjusts the network protocol stack state of the standby machine to be synchronized with the network protocol stack state of the active machine, and then may perform data packet transmission processing between the standby machine and the network element device for the SCTP based on the adjusted network protocol stack state of the standby machine.

The SCTP is a transmission protocol, and a plurality of data streams may be simultaneously transmitted between two ends of a network connection based on the protocol. The SCTP has a wide range of applications in a 4G/5G core network. For example, a signaling message between a base station and a user equipment (UE) is transmitted between a base station and a core network element device by using the SCTP. In 4G, a Diameter protocol is carried between network elements such as a mobility management entity (MME) and a home subscriber server (HSS) through the SCTP.

In an embodiment of this application, data packet transmission processing for a transmission control protocol (TCP) between the standby machine and the network element device may be performed based on the adjusted network protocol stack state of the standby machine.

The TCP is a connection-oriented, reliable, byte-stream-based transport layer communication protocol.

In an embodiment of this application, data packet transmission processing for a user datagram protocol (UDP) between the standby machine and the network element device may be performed based on the adjusted network protocol stack state of the standby machine.

The UDP is a connectionless transport layer protocol in an open system interconnection (OSI) reference model, and provides a transaction-oriented simple unreliable information transfer service.

In a practical application, data packet transmission processing of a transmission protocol targeted by the standby machine and the network element device may be performed based on a specific application scene.

For a detailed description of S201 and S202 shown in FIG. 7, reference is made to S201 and S202 shown in FIG. 2. Details are not described herein again.

In this embodiment of this application, based on the adjusted network protocol stack state of the standby machine, data packet transmission processing between the standby machine and the network element device for a plurality of network protocols may be performed, and the data packet transmission processing is applicable to a wide range of application scenes.

The embodiments shown in FIG. 2 to FIG. 7 is illustrated from a perspective of the standby machine. Implementation details of the technical solutions of the embodiments of this application are further described from a perspective of the network element device with reference to FIG. 8.

FIG. 8 is a flowchart of a data packet transmission control method based on an active machine and a standby machine according to an embodiment of this application. The data packet transmission control method based on an active machine and a standby machine may be performed by a network element device 103. As shown in FIG. 8, the data packet transmission control method based on an active machine and a standby machine includes at least operation S801 to operation S803. A detailed description is as follows.

S801: Obtain a data packet to be transmitted to a standby machine if it is detected that the standby machine switches to an active machine operating mode.

In this embodiment of this application, the network element device may detect an operating mode in which the standby machine is. If it is detected that the standby machine switches to the active machine operating mode, the data packet to be transmitted to the standby machine may be obtained.

The data packet to be transmitted to the standby machine obtained by the network element device includes a data packet that needs to be received (i.e., corresponding to the data packet to be transmitted by the standby machine in the foregoing embodiment) or a data packet to be transmitted (i.e., corresponding to the data packet to be received by the standby machine in the foregoing embodiment).

S802: Transmit the data packet to the standby machine, to cause the standby machine to obtain transmission indication information of the network element device for the data packet based on the data packet, and determine a to-be-transmitted data packet based on the transmission indication information.

In this embodiment of this application, the network element device obtains the data packet to be transmitted to the standby machine, and then may transmit the data packet to the standby machine. Correspondingly, the standby machine receives the data packet transmitted by the network element device, then obtains the transmission indication information of the network element device for the data packet based on the received data packet, and determines a to-be-transmitted data packet based on the transmission indication information. For the processing process on a standby machine side, reference is made to the description of the foregoing embodiments. Details are not described herein again.

S803: Receive the data packet transmitted by the standby machine.

In this embodiment of this application, the standby machine determines the to-be-transmitted data packet based on the transmission indication information, and then may transmit the determined to-be-transmitted data packet to the network element device. Correspondingly, the network element device receives the data packet transmitted by the standby machine.

In this embodiment of this application, the network element device transmits the data packet to be transmitted to the standby machine to the standby machine. In this way, the standby machine may quickly and conveniently determine, the transmission indication information of the network element device for the data packet based on the data packet, which provides strong support for subsequent synchronous adjustment of the network protocol stack state of the standby machine and the network protocol stack state of the active machine, and maintains consistency of the network protocol stack state of the standby machine and the network protocol stack state of the active machine, so that data packet transmission may be performed between the standby machine and the network element device, thereby improving rationality of data packet transmission control of the active machine and the standby machine, and ensuring normal processing of services after switching of the active machine and the standby machine.

A specific scene of the embodiments of this application is described in detail below.

Referring to FIG. 9, a base station, an SCTP proxy gateway, and an authentication management function (AMF) service are mainly included.

The base station includes a network element device, which corresponds to an external network element device in the foregoing embodiments.

The SCTP proxy gateway adopts a 1+1 active-standby scheme, including an active machine and a standby machine.

The AMF service includes a load balancer and a plurality of AMF instances. FIG. 9 shows 3 AMF instances. Exemplarily, an AMF may be deployed in the cloud. Functions of the AMF mainly include:
1) termination of an N2 interface of a control plane of the base station, and implementation of encoding and decoding of an NGAP (Protocol for NG Interface) message based on an SCTP protocol stack;
2) termination of an N1 interface of a user equipment (UE), and implementation of encryption and integrity protection of a non-access stratum (NAS) message;
3) responsible for functions such as UE access authentication, authorization management, registration, connection, reachability, and mobility management; and
4) responsible for transparent transmission of a session management message between the UE and a session management function (SMF).

The base station and the AMF may transmit the NGAP message through an SCTP transmission layer protocol stack, and carry the NAS message of the UE in the NGAP message. In this embodiment of this application, to support deployment of a 5G core network in the cloud, the SCTP proxy gateway is added to a front end of the AMF, so that an SCTP connection may be converted into a Google remote procedure call (gRPC) connection, an HTTP/2 connection, or a message queue (MQ), which enables the AMF to be deployed more flexibly and get rid of dependence on a cloud service provider.

Based on the implementation environment shown in FIG. 9, a process of synchronously updating a network protocol stack state of a standby machine is first described.

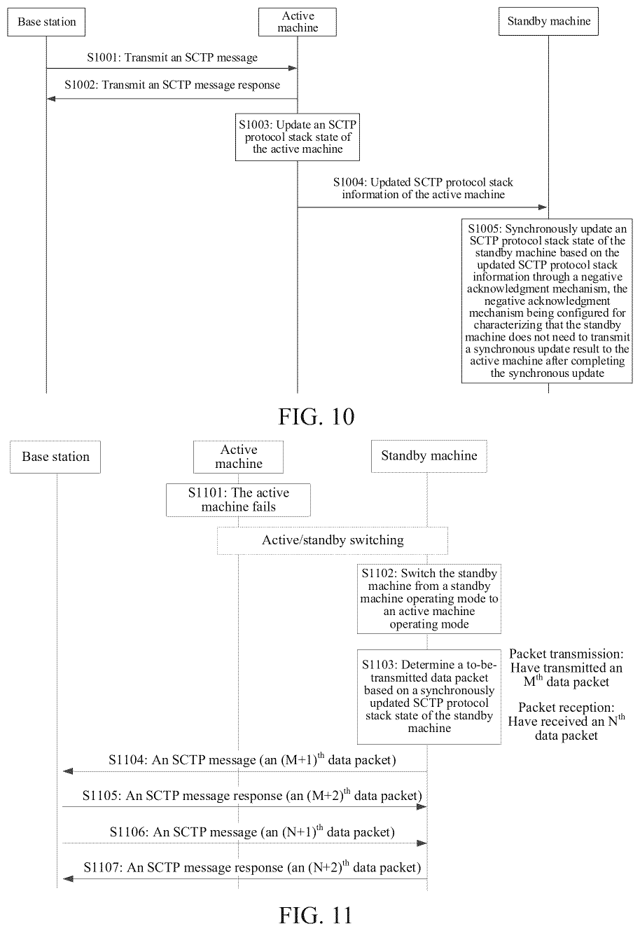

FIG. 10 is a flowchart of a data packet transmission control method based on an active machine and a standby machine according to an embodiment of this application. As shown in FIG. 10, the data packet transmission control method based on an active machine and a standby machine includes at least operation S1001 to operation S1005. A detailed description is as follows.

S1001: An active machine transmits an SCTP message to a base station.

S1002: The base station transmits an SCTP message response for the SCTP message to the active machine.

S1003: The active machine updates an SCTP protocol stack state of the active machine.

S1004: The active machine generates a synchronous request, the synchronous request carrying updated SCTP protocol stack information of the active machine.

S1005: The standby machine synchronously updates the SCTP protocol stack state of the standby machine based on the updated SCTP protocol stack information through a negative acknowledgment mechanism, the negative acknowledgment mechanism being configured for characterizing that the standby machine does not need to transmit a synchronous update result to the active machine after completing the synchronous update.

S1001 to S1005 shown in FIG. 10 are for a synchronous update process of the SCTP protocol stack state of a single standby machine. The synchronous update process is generally performed in a plurality of cycles. In a practical application, an adjustment may be flexibly made based on a specific application scene.

For a detailed description of S1001 to S1005 shown in FIG. 10, reference is made to the foregoing embodiments. Details are not described herein again.

In this embodiment of this application, the standby machine synchronously updates the SCTP protocol stack state of the standby machine by using the negative acknowledgment mechanism, which saves a specific acknowledgement resource and improves efficiency of synchronously updating the SCTP protocol stack state of the standby machine.

Based on the implementation environment shown in FIG. 9, a data packet transmission process between the standby machine and the network element device when the SCTP protocol stack state of the standby machine is completely synchronized with the SCTP protocol stack state of the active machine is described next.

FIG. 11 is a flowchart of a data packet transmission control method based on an active machine and a standby machine according to an embodiment of this application. As shown in FIG. 11, the data packet transmission control method based on an active machine and a standby machine includes at least operation S1101 to operation S1107. A detailed description is as follows.

S1101: An active machine fails.

S1102: A standby machine switches from a standby machine operating mode to an active machine operating mode.

S1103: The standby machine determines a to-be-transmitted data packet based on a synchronously updated SCTP protocol stack state of the standby machine.

Exemplarily, a packet transmission quantity included in the SCTP protocol stack state of the standby machine is synchronized with a packet transmission quantity included in the SCTP protocol stack state of the active machine. For example, the packet transmission quantity is M. In other words, an M^{th} data packet has been transmitted.

Exemplarily, a packet reception quantity included in the SCTP protocol stack state of the standby machine is synchronized with a packet reception quantity included in the SCTP protocol stack state of the active machine. For example, the packet reception quantity is N. In other words, an N^{th} data packet has been received.

S1104: The standby machine transmits an SCTP message to a base station, the SCTP message being for an (M+1)^{th} data packet.

S1105: The base station transmits an SCTP message response for the SCTP message to the standby machine, the SCTP message response being for an (M+2)^{th} data packet.

S1106: The base station transmits the SCTP message to the standby machine, the SCTP message being for an (N+1)^{th} data packet.

S1107: The standby machine transmits the SCTP message response for the SCTP message to the base station, the SCTP message response being for an (N+2)^{th} data packet.

S1104 to S1105 and S1106 to S1107 shown in FIG. 11 may be performed either first or later. In a practical application, an adjustment may be flexibly made based on a specific application scene.

For a detailed description of S1101 to S1107 shown in FIG. 11, reference is made to the foregoing embodiments. Details are not described herein again.

In this embodiment of this application, when the SCTP protocol stack state of the standby machine is completely synchronized with the SCTP protocol stack state of the active machine, data packet transmission may be performed between the standby machine and the network element device.

Based on the implementation environment shown in FIG. 9, a data packet transmission process between the standby machine and the network element device when the SCTP protocol stack state of the standby machine is not completely synchronized with the SCTP protocol stack state of the active machine is described again.

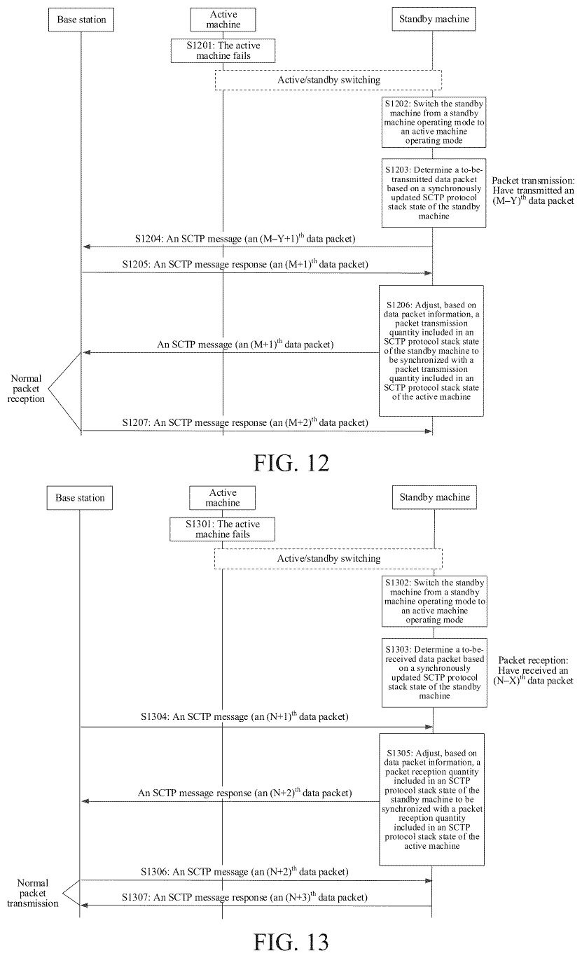

FIG. 12 is a flowchart of a data packet transmission control method based on an active machine and a standby machine according to an embodiment of this application. As shown in FIG. 12, the data packet transmission control method based on an active machine and a standby machine includes at least S1201 to S1207. A detailed description is as follows.

S1201: An active machine fails.

S1202: A standby machine switches from a standby machine operating mode to an active machine operating mode.

S1203: The standby machine determines a to-be-transmitted data packet based on a synchronously updated SCTP protocol stack state of the standby machine.

Exemplarily, a packet transmission quantity included in the SCTP protocol stack state of the standby machine is not completely synchronized with a packet transmission quantity included in an SCTP protocol stack state of the active machine. For example, the packet transmission quantity included in the SCTP protocol stack state of the standby machine is M−Y, which means that an (M−Y)^{th} data packet has been transmitted. However, an actual packet transmission quantity included in the SCTP protocol stack state of the active machine is M, which means that an M^{th} data packet has been transmitted.

The standby machine determines, based on the synchronously updated SCTP protocol stack state of the standby machine, that the to-be-transmitted data packet is an (M-Y+1)^{th} data packet.

S1204: The standby machine transmits an SCTP message to a base station, the SCTP message being for the (M−Y+1)^{th} data packet.

S1205: The base station transmits an SCTP message response to the SCTP message to the standby machine, the SCTP message response being for an (M+1)^{th} data packet.

The SCTP message response is the packet transmission indication information in the foregoing embodiments. To be specific, the packet transmission indication information is configured for indicating that the standby machine needs to transmit the (M+1)^{th} data packet to the base station.

S1206: The standby machine adjusts, based on data packet information, the packet transmission quantity included in the SCTP protocol stack state of the standby machine to be synchronized with the packet transmission quantity included in the SCTP protocol stack state of the active machine, and transmits the SCTP message to the standby machine, the SCTP message being for the (M+1)^{th} data packet.

The standby machine adjusts the packet transmission quantity included in the SCTP protocol stack state of the standby machine to be synchronized with the packet transmission quantity included in the SCTP protocol stack state of the active machine based on the data packet information. In other words, the packet transmission quantities are both M, which means that the M^{th} data packet has been transmitted. In this case, the (M+1)^{th} data packet needs to be transmitted to the standby machine.

S1207: The base station transmits an SCTP message response to the SCTP message to the standby machine, the SCTP message response being for an (M+2)^{th} data packet.

For a detailed description of S1201 to S1207 shown in FIG. 12, reference is made to the foregoing embodiments. Details are not described herein again.

In this embodiment of this application, when the packet transmission quantity included in the SCTP protocol stack state of the standby machine is not completely synchronized with the packet transmission quantity included in the SCTP protocol stack state of the active machine, the standby machine maintains consistency of the packet transmission quantity included in the SCTP protocol stack state of the standby machine and the packet transmission quantity included in the SCTP protocol stack state of the active machine through the packet transmission indication information, so that data packet transmission may be performed between the standby machine and the network element device, thereby improving rationality of data packet transmission control of the active machine and the standby machine, and ensuring normal processing of services after switching of the active machine and the standby machine.

FIG. 13 is a flowchart of a data packet transmission control method based on an active machine and a standby machine according to an embodiment of this application. As shown in FIG. 13, the data packet transmission control method based on an active machine and a standby machine includes at least operation S1301 to operation S1307. A detailed description is as follows.

S1301: An active machine fails.

S1302: A standby machine switches from a standby machine operating mode to an active machine operating mode.

S1303. The standby machine determines a to-be-received data packet based on a synchronously updated SCTP protocol stack state of the standby machine.

Exemplarily, a packet reception quantity included in the SCTP protocol stack state of the standby machine is not completely synchronized with a packet reception quantity included in the SCTP protocol stack state of the active machine. For example, the packet reception quantity included in the SCTP protocol stack state of the standby machine is N−X. In other words, an (N−X)^{th} data packet has been received. An actual packet reception quantity included in the SCTP protocol stack state of the active machine is N. In other words, an N^{th} data packet has been received.

The standby machine determines, based on the synchronously updated SCTP protocol stack state of the standby machine, that the to-be-received data packet is an (N-X+1)^{th} data packet.

S1304: The base station transmits the SCTP message to the standby machine, the SCTP message being for an (N+1)^{th} data packet.

The SCTP message is the packet reception indication information in the foregoing embodiments. To be specific, the packet reception indication information is configured for indicating that the standby machine needs to receive the (N+1)^{th} data packet transmitted by the base station.

S1305: The standby machine adjusts the packet reception quantity included in the SCTP protocol stack state of the standby machine to be synchronized with the packet reception quantity included in the SCTP protocol stack state of the active machine based on the data packet information, and transmits an SCTP message response for the SCTP message to the base station, the SCTP message response being for an (N+2)^{th} data packet.

The standby machine adjusts the packet reception quantity included in the SCTP protocol stack state of the standby machine to be synchronized with the packet reception quantity included in the SCTP protocol stack state of the active machine based on the data packet information. In other words, the packet reception quantity is N, to be specific, an N^{th} data packet has been received. In addition, because the (N+1)^{th} data packet transmitted by the network element device has been received, the packet reception quantity included in the SCTP protocol stack state of the standby machine needs to updated again in this case. To be specific, the packet reception quantity is N+1.

S1306: The base station transmits the SCTP message to the standby machine, the SCTP message being for the (N+2)^{th} data packet.

S1307: The standby machine transmits the SCTP message response for the SCTP message to the base station, the SCTP message response being for an (N+3)^{th} data packet.

For a detailed description of S1301 to S1307 shown in FIG. 13, reference is made to the foregoing embodiments. Details are not described herein again.

In this embodiment of this application, when the packet reception quantity included in the SCTP protocol stack state of the standby machine is not completely synchronized with the packet reception quantity included in the SCTP protocol stack state of the active machine, the standby machine maintains consistency of the packet reception quantity included in the SCTP protocol stack state of the standby machine and the packet reception quantity included in the SCTP protocol stack state of the active machine through the packet reception indication information, so that data packet transmission may be performed between the standby machine and the network element device, thereby improving rationality of data packet transmission control of the active machine and the standby machine, and ensuring normal processing of services after switching of the active machine and the standby machine.

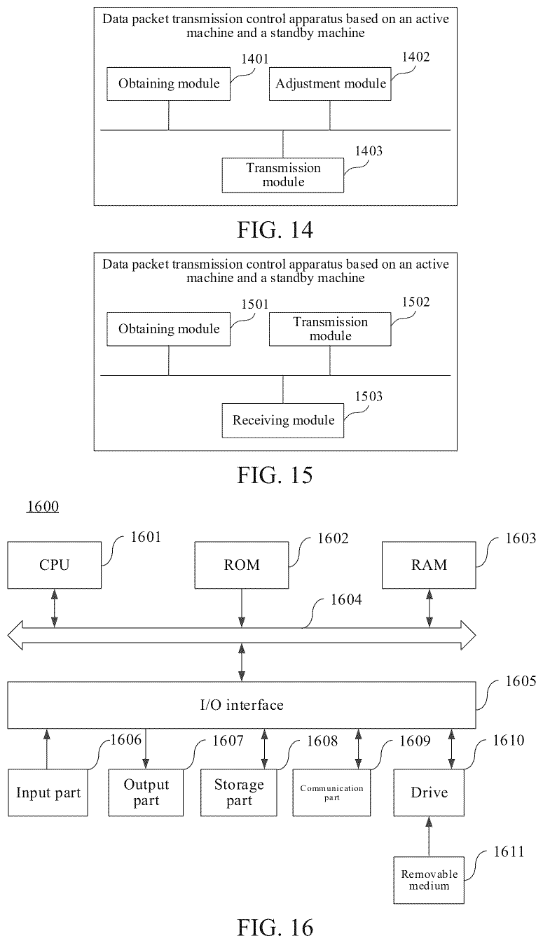

FIG. 14 is a block diagram of a data packet transmission control apparatus based on an active machine and a standby machine according to an embodiment of this application. As shown in FIG. 14, the data packet transmission control apparatus based on an active machine and a standby machine includes:
an obtaining module 1401, configured to obtain transmission indication information from a network element device for a data packet after the standby machine switches from a standby machine operating mode to an active machine operating mode, the transmission indication information being configured for indicating data packet information of a data packet to be transmitted between the standby machine and the network element device;
an adjustment module 1402, configured to adjust a network protocol stack state of the standby machine to be synchronized with a network protocol stack state of the active machine based on the data packet information; and
a transmission module 1403, configured to perform data packet transmission processing between the standby machine and the network element device based on an adjusted network protocol stack state of the standby machine.

In an embodiment of this application, the data packet information includes target identification information, the network protocol stack state of the standby machine including quantity information corresponding to transmitted data packets between the active machine and the network element device. The adjustment module 1402 is specifically configured to:
determine transmission identification information of the transmitted data packets based on the target identification information; and
adjust the quantity information to quantity information matching the transmission identification information, to cause the network protocol stack state of the standby machine to be synchronized with the network protocol stack state of the active machine.

In an embodiment of this application, the transmission indication information includes packet transmission indication information for indicating target identification information corresponding to a data packet to be transmitted by the standby machine, the target identification information including first identification information, and the quantity information being configured for characterizing a packet transmission quantity corresponding to data packets that have been transmitted by the active machine to the network element device. The adjustment module 1402 is further configured to:
use previous identification information adjacent to the target identification information as transmission identification information of the transmitted data packet; and
adjust the packet transmission quantity to a packet transmission quantity matching the transmission identification information.

In an embodiment of this application, the transmission indication information includes packet reception indication information for indicating target identification information corresponding to a data packet to be received by the standby machine, the target identification information including second identification information, and the quantity information being configured for characterizing a packet reception quantity corresponding to data packets transmitted by the network element device that have been received by the active machine. The adjustment module 1402 is further configured to:
use previous identification information adjacent to the target identification information as receiving identification information of the received data packet; and
adjust the packet reception quantity to a packet reception quantity matching the receiving identification information.

In an embodiment of this application, the data packet information includes target identification information, the network protocol stack state of the standby machine including quantity information corresponding to transmitted data packets between the active machine and the network element device. The adjustment module 1402 is specifically configured to:
detect a synchronization status between the network protocol stack state of the standby machine and the network protocol stack state of the active machine based on a relationship between the target identification information and the quantity information; and
adjust the network protocol stack state of the standby machine to be synchronized with the network protocol stack state of the active machine based on the target identification information if the synchronization status characterizes that the network protocol stack state of the standby machine is not completely synchronized with the network protocol stack state of the active machine.

In an embodiment of this application, the adjustment module 1402 is further configured to:
determine third identification information corresponding to a to-be-transmitted data packet based on the quantity information;
obtain a detection result for characterizing that the network protocol stack state of the standby machine is not completely synchronized with the network protocol stack state of the active machine if the target identification information does not match the third identification information; and
obtain a detection result for characterizing that the network protocol stack state of the standby machine is completely synchronized with the network protocol stack state of the active machine if the target identification information matches the third identification information.

In an embodiment of this application, the obtaining module 1401 is specifically configured to:
receive a data packet transmitted by the network element device; and
determine the transmission indication information of the network element device for the data packet based on the received data packet.

In an embodiment of this application, the obtaining module 1401 is further configured to:
transmit a data packet with specified identification information to the network element device based on the network protocol stack state of the standby machine;
receive a data packet fed back by the network element device based on the data packet with the specified identification information;
determine packet transmission indication information of the standby machine for the data packet based on data packet information corresponding to the received data packet, the packet transmission indication information being configured for indicating data packet information of a data packet to be transmitted by the standby machine; and
use the packet transmission indication information as the transmission indication information.

In an embodiment of this application, the obtaining module 1401 is further configured to:
determine third identification information corresponding to a to-be-transmitted data packet based on the packet transmission quantity included in the network protocol stack state of the standby machine, and use the determined third identification information as the specified identification information; and
transmit the data packet with the specified identification information to the network element device.

In an embodiment of this application, the obtaining module 1401 is further configured to:
determine packet reception indication information of the standby machine for the data packet based on data packet information corresponding to the received data packet, the packet reception indication information being configured for indicating data packet information of a data packet to be received by the standby machine; and
use the packet reception indication information as the transmission indication information.

In an embodiment of this application, the data packet transmission control apparatus based on an active machine and a standby machine further includes:
a receiving module, configured to receive a synchronous request transmitted by the active machine, the synchronous request being generated after the active machine updates the network protocol stack state of the active machine, and the synchronous request carrying updated network protocol stack information of the active machine; and
a synchronous update module, configured to synchronously update the network protocol stack state of the standby machine based on the updated network protocol stack information.

In an embodiment of this application, the synchronous update module is specifically configured to:
synchronously update the network protocol stack state of the standby machine based on the updated network protocol stack information through a negative acknowledgment mechanism, the negative acknowledgment mechanism being configured for characterizing that the standby machine does not need to transmit a synchronous update result to the active machine after completing the synchronous update.

In an embodiment of this application, the synchronous update module is specifically configured to:
synchronously update the packet transmission quantity included in the network protocol stack state of the standby machine based on the updated network protocol stack information if the updated network protocol stack information is for a case when the active machine transmits the data packet to the network element device, to cause the packet transmission quantity included in the network protocol stack state of the standby machine to be synchronized with the packet transmission quantity included in the network protocol stack state of the active machine.

In an embodiment of this application, the synchronous update module is specifically configured to:
synchronously update the packet reception quantity included in the network protocol stack state of the standby machine based on the updated network protocol stack information if the updated network protocol stack information is for a case when the active machine receives the data packet transmitted by the network element device, to cause the packet reception quantity included in the network protocol stack state of the standby machine to be synchronized with the packet reception quantity included in the network protocol stack state of the active machine.

In an embodiment of this application, the network element device includes at least one of a separately arranged network element device and a network element device arranged in a base station. The transmission module 1403 is specifically configured to:
perform data packet transmission processing for an SCTP between the standby machine and the network element device based on the adjusted network protocol stack state of the standby machine.

In an embodiment of this application, the network element device includes at least one of a separately arranged network element device and a network element device arranged in a base station. The transmission module 1403 is specifically configured to:
perform data packet transmission processing for a TCP between the standby machine and the network element device based on the adjusted network protocol stack state of the standby machine.

In an embodiment of this application, the network element device includes at least one of a separately arranged network element device and a network element device arranged in a base station. The transmission module 1403 is specifically configured to:
perform data packet transmission processing for a UDP between the standby machine and the network element device based on the adjusted network protocol stack state of the standby machine.

FIG. 15 is a block diagram of a data packet transmission control apparatus based on an active machine and a standby machine according to an embodiment of this application. As shown in FIG. 15, the data packet transmission control apparatus based on an active machine and a standby machine includes:
an obtaining module 1501, configured to obtain a data packet to be transmitted to a network element device if it is detected that the standby machine switches to an active machine operating mode;
a transmission module 1502, configured to transmit the data packet to the standby machine, to cause the standby machine to obtain transmission indication information of the network element device for the data packet based on the data packet, and determine a to-be-transmitted data packet based on the transmission indication information; and
a receiving module 1503, configured to receive the data packet transmitted by the standby machine.

The apparatus provided in the foregoing embodiment and the method provided in the foregoing embodiment are based on the same concept. Specific manners in which the modules and units perform operations have been described in detail in the method embodiments.

An embodiment of this application further provides an electronic device, including: one or more processors; and a memory, configured to store one or more programs, the one or more programs, when executed by one or more processors, causing the electronic device to implement the foregoing data packet transmission control method based on an active machine and a standby machine.

FIG. 16 is a schematic structural diagram of a computer system adapted to implement an electronic device according to an embodiment of this application.

A computer system 1600 of the electronic device shown in FIG. 16 is merely an example, and does not impose any limitation on a function and use scope of this embodiment of this application.

As shown in FIG. 16, the computer system 1600 includes a central processing unit (CPU) 1601, which may perform various suitable actions and processing based on a program stored in a read-only memory (ROM) 1602 or a program loaded from a storage part 1608 into a random access memory (RAM) 1603, for example, perform the method described in the foregoing embodiments. The RAM 1603 further has various programs and data required for system operation stored therein. The CPU 1601, the ROM 1602, and the RAM 1603 are connected to each other through a bus 1604. An input/output (I/O) interface 1605 is also connected to the bus 1604.

The following components are connected to the I/O interface 1605: an input part 1606 including a keyboard and a mouse; an output part 1607 including a cathode ray tube (CRT), a liquid crystal display (LCD), a speaker, or the like; a storage part 1608 including a hard disk, or the like; and a communication part 1609 including a network interface card such as a local area network (LAN) card and a modem. The communication part 1609 performs communication processing by using a network such as the Internet. A driver 1610 is also connected to the I/O interface 1605 as required. A removable medium 1611, such as a magnetic disk, an optical disc, a magneto-optical disk, or a semiconductor memory, is installed on the drive 1610 as required, so that a computer program read from the removable medium is installed into the storage part 1608 as required.

Particularly, according to an embodiment of this application, the processes described in the following by referring to the flowcharts may be implemented as computer software programs. For example, an embodiment of this application includes a computer program product. The computer program product includes a computer program stored in a computer-readable medium. The computer program includes a computer program configured for performing a method shown in the flowchart. In such an embodiment, the computer program may be downloaded and installed from a network through the communication part 1609, and/or installed from the removable medium 1611. When the computer program is executed by the CPU 1601, the various functions defined in the system of this application are executed.

The computer-readable medium shown in the embodiments of this application may be a computer-readable signal medium or a computer-readable storage medium or any combination of the two media. The computer-readable medium may be, for example, an electrical, magnetic, optical, electromagnetic, infrared, or semiconductor system, apparatus, or device, or any combination thereof. More specific examples of the computer-readable medium may include, but are not limited to: an electrical connection having one or more wires, a portable computer magnetic disk, a hard disk, a RAM, a ROM, an erasable programmable read-only memory (EPROM), a flash memory, an optical fiber, a compact disk read-only memory (CD-ROM), an optical storage device, a magnetic storage device, or any suitable combination thereof. In this application, the computer-readable medium may be any tangible medium having a program included or stored therein, and the program may be used by or used in combination with an instruction execution system, an apparatus, or a device. In this application, the computer-readable signal medium may include a data signal transmitted in a baseband or as a part of a carrier, and carries a computer-readable computer program. A data signal propagated in such a way may assume a plurality of forms, including, but not limited to, an electromagnetic signal, an optical signal, or any suitable combination thereof. The computer-readable signal medium may alternatively be any computer-readable medium other than a computer-readable storage medium. The computer-readable medium may transmit, propagate, or transmit a program that is used by or used in conjunction with an instruction execution system, an apparatus, or a device. The computer program included in the computer-readable medium may be transmitted by using any suitable medium, including but not limited to wireless transmission, a wired transmission, or any other suitable combination thereof.

The flowcharts and block diagrams in the accompanying drawings illustrate possible system architectures, functions and operations that may be implemented by a system, a method, and a computer program product according to various embodiments of this application. Each box in the flowcharts or the block diagrams may represent a module, a program segment, or a part of code. The module, the program segment, or the part of the code includes one or more executable instructions configured for implementing a specified logical function. In some alternative implementations, functions annotated in the boxes may also be executed in a different order from those annotated in the accompanying drawings. For example, two boxes shown in succession may actually be performed basically in parallel, and sometimes the two boxes may be performed in a reverse order. This is determined by a related function. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The involved units described in the embodiments of this application may be implemented by software or hardware, and the described units may alternatively be arranged in a processor. Names of the units do not constitute a limitation on the units in a specific case.

Another aspect of this application further provides a computer-readable medium, having a computer program stored therein, the computer program, when executed by a processor, implementing the foregoing data packet transmission control method based on an active machine and a standby machine. The computer-readable medium may be included in the electronic device described in the foregoing embodiments, or may exist alone without being installed into the electronic device.

Another aspect of this application further provides a computer program product or a computer program, the computer program product or the computer program including a computer instruction, the computer instruction being stored in a computer-readable medium. A processor of a computer device reads the computer instruction from the computer-readable medium, and the processor executes the computer instruction to cause the computer device to perform the data packet transmission control method based on an active machine and a standby machine method provided in the foregoing various embodiments.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing descriptions are merely preferable exemplary embodiments of this application, and are not intended to limit the implementations of this application. A person of ordinary skill in the art may make corresponding variations or modifications with ease according to the main concept and spirit of this application. Therefore, the protection scope of this application needs to be subject to the protection scope of the claims.

What is claimed is:

1. A data packet transmission control method based on an active machine and a standby machine, the method comprising:
obtaining transmission indication information from a network element device for a data packet after the standby machine switches from a standby machine operating mode to an active machine operating mode, the transmission indication information indicating data packet information of a data packet to be transmitted between the standby machine and the network element device;
adjusting a network protocol stack state of the standby machine to be synchronized with a network protocol stack state of the active machine based on the data packet information; and
performing data packet transmission processing between the standby machine and the network element device based on the adjusted network protocol stack state of the standby machine.

2. The method according to claim 1, wherein the data packet information comprises target identification information, the network protocol stack state of the standby machine comprising quantity information corresponding to transmitted data packets between the active machine and the network element device, and
the adjusting a network protocol stack state of the standby machine to be synchronized with a network protocol stack state of the active machine based on the data packet information comprises:
determining transmission identification information of the transmitted data packets based on the target identification information; and
adjusting the quantity information to quantity information matching the transmission identification information, to cause the network protocol stack state of the standby machine to be synchronized with the network protocol stack state of the active machine.

3. The method according to claim 2, wherein the transmission indication information comprises packet transmission indication information for indicating target identification information corresponding to a data packet to be transmitted by the standby machine, the target identification information comprising first identification information, and the quantity information being configured for characterizing a packet transmission quantity corresponding to data packets that have been transmitted by the active machine to the network element device;
the determining transmission identification information of the transmitted data packet based on the target identification information comprises:
using previous identification information adjacent to the target identification information as transmission identification information of the transmitted data packet; and
the adjusting the quantity information to quantity information matching the transmission identification information comprises:
adjusting the packet transmission quantity to a packet transmission quantity matching the transmission identification information.

4. The method according to claim 2, wherein the transmission indication information comprises packet reception indication information for indicating target identification information corresponding to a data packet to be received by the standby machine, the target identification information comprising second identification information, and the quantity information being configured for characterizing a packet reception quantity corresponding to data packets transmitted by the network element device that have been received by the active machine;
the determining transmission identification information of the transmitted data packet based on the target identification information comprises:
using previous identification information adjacent to the target identification information as receiving identification information of the received data packet; and
the adjusting the quantity information to quantity information matching the transmission identification information comprises:
adjusting the packet reception quantity to a packet reception quantity matching the receiving identification information.

5. The method according to claim 1, wherein the data packet information comprises target identification information, the network protocol stack state of the standby machine comprising quantity information corresponding to transmitted data packets between the active machine and the network element device, and
the adjusting a network protocol stack state of the standby machine to be synchronized with a network protocol stack state of the active machine based on the data packet information comprises:
detecting a synchronization status between the network protocol stack state of the standby machine and the network protocol stack state of the active machine based on a relationship between the target identification information and the quantity information; and
adjusting the network protocol stack state of the standby machine to be synchronized with the network protocol stack state of the active machine based on the target identification information if the synchronization status characterizes that the network protocol stack state of the standby machine is not completely synchronized with the network protocol stack state of the active machine.

6. The method according to claim 5, wherein the detecting a synchronization status between the network protocol stack state of the standby machine and the network protocol stack state of the active machine based on a relationship between the target identification information and the quantity information comprises:
determining third identification information corresponding to a to-be-transmitted data packet based on the quantity information;
obtaining a detection result for characterizing that the network protocol stack state of the standby machine is not completely synchronized with the network protocol stack state of the active machine if the target identification information does not match the third identification information; and
obtaining a detection result for characterizing that the network protocol stack state of the standby machine is completely synchronized with the network protocol stack state of the active machine if the target identification information matches the third identification information.

7. The method according to claim 1, wherein the obtaining transmission indication information from a network element device for a data packet comprises:
receiving a data packet transmitted by the network element device; and
determining the transmission indication information of the network element device based on the received data packet.

8. The method according to claim 7, wherein the receiving a data packet transmitted by the network element device comprises:
transmitting a data packet with specified identification information to the network element device based on the network protocol stack state of the standby machine; and
receiving a data packet fed back by the network element device based on the data packet with the specified identification information; and
the determining the transmission indication information of the network element device for the data packet based on the received data packet comprises:
determining packet transmission indication information of the standby machine for the data packet based on data packet information corresponding to the received data packet, the packet transmission indication information being configured for indicating data packet information of a data packet to be transmitted by the standby machine; and
using the packet transmission indication information as the transmission indication information.

9. The method according to claim 8, wherein the transmitting a data packet with specified identification information to the network element device based on the network protocol stack state of the standby machine comprises:
determining third identification information corresponding to a to-be-transmitted data packet based on the packet transmission quantity comprised in the network protocol stack state of the standby machine, and using the determined third identification information as the specified identification information; and
transmitting the data packet with the specified identification information to the network element device.

10. The method according to claim 7, wherein the determining the transmission indication information of the network element device for the data packet based on the received data packet comprises:
determining packet reception indication information of the standby machine for the data packet based on data packet information corresponding to the received data packet, the packet reception indication information being configured for indicating data packet information of a data packet to be received by the standby machine; and
using the packet reception indication information as the transmission indication information.

11. The method according to claim 1, further comprising:
receiving a synchronous request transmitted by the active machine, the synchronous request carrying updated network protocol stack information of the active machine; and
synchronously updating the network protocol stack state of the standby machine based on the updated network protocol stack information.

12. The method according to claim 11, wherein the synchronously updating the network protocol stack state of the standby machine based on the updated network protocol stack information comprises:
synchronously updating the network protocol stack state of the standby machine based on the updated network protocol stack information through a negative acknowledgment mechanism, the negative acknowledgment mechanism being configured for characterizing that the standby machine does not need to transmit a synchronous update result to the active machine after completing the synchronous update.

13. The method according to claim 11, wherein the synchronously updating the network protocol stack state of the standby machine based on the updated network protocol stack information comprises:
synchronously updating the packet transmission quantity comprised in the network protocol stack state of the standby machine based on the updated network protocol stack information if the updated network protocol stack information is for a case when the active machine transmits the data packet to the network element device, to cause the packet transmission quantity comprised in the network protocol stack state of the standby machine to be synchronized with the packet transmission quantity comprised in the network protocol stack state of the active machine.

14. The method according to claim 11, wherein the synchronously updating the network protocol stack state of the standby machine based on the updated network protocol stack information comprises:
synchronously updating the packet reception quantity comprised in the network protocol stack state of the standby machine based on the updated network protocol stack information if the updated network protocol stack information is for a case when the active machine receives the data packet transmitted by the network element device, to cause the packet reception quantity comprised in the network protocol stack state of the standby machine to be synchronized with the packet reception quantity comprised in the network protocol stack state of the active machine.

15. The method according to claim 1, wherein the network element device comprises at least one of a separately arranged network element device and a network element device arranged in a base station.
performing data packet transmission processing for a stream control transmission protocol (SCTP) between the standby machine and the network element device based on the adjusted network protocol stack state of the standby machine.

16. The method according to claim 1, wherein the performing data packet transmission processing between the standby machine and the network element device based on the adjusted network protocol stack state of the standby machine comprises:
performing data packet transmission processing for one of a transmission control protocol (TCP) or a stream control transmission protocol (SCTP) or a user datagram protocol (UDP) between the standby machine and the network element device based on the adjusted network protocol stack state of the standby machine.

17. An electronic device, comprising:
one or more processors; and
a memory, configured to store one or more programs, the one or more programs, when executed by the electronic device, causing the electronic device to implement a data packet transmission control method based on an active machine and a standby machine including:
obtaining transmission indication information from a network element device for a data packet after the standby machine switches from a standby machine operating mode to an active machine operating mode, the transmission indication information indicating data packet information of a data packet to be transmitted between the standby machine and the network element device;
adjusting a network protocol stack state of the standby machine to be synchronized with a network protocol stack state of the active machine based on the data packet information; and
performing data packet transmission processing between the standby machine and the network element device based on the adjusted network protocol stack state of the standby machine.

18. The electronic device according to claim 17, wherein the data packet information comprises target identification information, the network protocol stack state of the standby machine comprising quantity information corresponding to transmitted data packets between the active machine and the network element device, and
the adjusting a network protocol stack state of the standby machine to be synchronized with a network protocol stack state of the active machine based on the data packet information comprises:
determining transmission identification information of the transmitted data packets based on the target identification information; and
adjusting the quantity information to quantity information matching the transmission identification information, to cause the network protocol stack state of the standby machine to be synchronized with the network protocol stack state of the active machine.

19. The electronic device according to claim 17, wherein the obtaining transmission indication information from a network element device for a data packet comprises:
receiving a data packet transmitted by the network element device; and
determining the transmission indication information of the network element device based on the received data packet.

20. A non-transitory computer-readable medium, having one or more computer programs stored therein, the one or more computer programs, when executed by a processor of an electronic device, causing the electronic device to implement a data packet transmission control method based on an active machine and a standby machine including:
obtaining transmission indication information from a network element device for a data packet after the standby machine switches from a standby machine operating mode to an active machine operating mode, the transmission indication information indicating data packet information of a data packet to be transmitted between the standby machine and the network element device;
adjusting a network protocol stack state of the standby machine to be synchronized with a network protocol stack state of the active machine based on the data packet information; and
performing data packet transmission processing between the standby machine and the network element device based on the adjusted network protocol stack state of the standby machine.
